(19) United States
(12) Patent Application Publication
(10) Pub. No.: US 2015/0205957 A1
(43) Pub. Date: Jul. 23, 2015

(54) METHOD, DEVICE, AND SYSTEM OF DIFFERENTIATING BETWEEN A LEGITIMATE USER AND A CYBER-ATTACKER

(71) Applicant: BioCatch Ltd., Tel Aviv (IL)

(72) Inventors: Avi Turgeman, Cambridge, MA (US); Oren Kedem, Tel Aviv (IL); Uri Rivner, Mazkeret Batya (IL)

(21) Appl. No.: 14/675,764

(22) Filed: Apr. 1, 2015

Related U.S. Application Data
(63) Continuation-in-part of application No. 14/566,723, filed on Dec. 11, 2014.
Application No. 14/566,723 is a continuation of application No. 13/922,271, filed on Jun. 20, 2013, now Pat. No. 8,938,787.
Application No. 13/922,271 is a continuation-in-part of application No. 13/877,676, filed on Apr. 4, 2013.
Application No. 13/877,676 is a continuation-in-part of application No. 14/320,653, filed on Jul. 1, 2014.
Application No. 14/320,653 is a continuation-in-part of application No. 14/320,656, filed on Jul. 1, 2014.
Application No. 14/320,656 is a continuation-in-part of application No. 14/325,393, filed on Jul. 8, 2014.
Application No. 14/325,393 is a continuation-in-part of application No. 14/325,394, filed on Jul. 8, 2014.
Application No. 14/325,394 is a continuation-in-part of application No. 14/325,395, filed on Jul. 8, 2014.
Application No. 14/325,395 is a continuation-in-part of application No. 14/325,396, filed on Jul. 8, 2014.
Application No. 14/325,396 is a continuation-in-part of application No. 14/325,397, filed on Jul. 8, 2014.
Application No. 14/325,397 is a continuation-in-part of application No. 14/325,398, filed on Jul. 8, 2014.
(60) Provisional application No. 61/973,855, filed on Apr. 2, 2014.
(60) Provisional application No. 61/417,479, filed on Nov. 29, 2010.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.
(60) Provisional application No. 61/843,915, filed on Jul. 9, 2013.

(51) Int. Cl. G06F 21/55; G06N 5/04

(52) U.S. Cl. CPC G06F 21/554; G06N 5/04; G06F 2221/034

(57) ABSTRACT

Devices, systems, and methods of detecting user identity, differentiating between users of a computerized service, and detecting a cyber-attacker. An end-user device (a desktop computer, a laptop computer, a smartphone, a tablet, or the like) interacts and communicates with a server of a computerized server (a banking website, an electronic commerce website, or the like). The interactions are monitored, tracked and logged. User Interface (UI) interferences are intentionally introduced to the communication session; and the server tracks the response or the reaction of the end-user to such communication interferences. The system determines whether the user is a legitimate human user, or a cyber-attacker posing as the legitimate human user.

### CROSS-REFERENCE TO RELATED APPLICATIONS

This application claims priority and benefit from U.S. provisional patent application No. 61/973,855, titled “Method, Device, and System of Detecting Identity of a User of an Electronic Service”, filed on Apr. 2, 2014, which is hereby incorporated by reference in its entirety.

This application is a Continuation-in-Part (CIP) of, and claims priority and benefit from, U.S. patent application Ser. No. 14/566,723, filed on Dec. 11, 2014; which is a Continuation of U.S. patent application Ser. No. 13/922,271, filed on Jun. 20, 2013, now U.S. Pat. No. 8,938,787; which is a Continuation-in-Part (CIP) of U.S. patent application Ser. No. 13/877,676, filed on Apr. 4, 2013; which is a National Stage of PCT International Application number PCT/IL2011/000907, having an International Filing Date of Nov. 29, 2011; which claims priority and benefit from U.S. provisional patent application No. 61/417,479, filed on Nov. 29, 2010; all of which are hereby incorporated by reference in their entirety.

This application is a Continuation-in-Part (CIP) of, and claims priority and benefit from, U.S. patent application Ser. No. 14/320,653, filed on Jul. 1, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/320,656, filed on Jul. 1, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,393, filed on Jul. 8, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,394, filed on Jul. 8, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,395, filed on Jul. 8, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,396, filed on Jul. 8, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,397, filed on Jul. 8, 2014; which claims priority and benefit from U.S. provisional patent application No. 61/843,915, filed on Jul. 9, 2013; all of which are hereby incorporated by reference in their entirety.

This application is a Continuation-in-Part (CIP) of, and claims priority and benefit from, U.S. patent application Ser. No. 14/325,398, filed on Jul. 8, 2014; which claims priority and benefit from U.S. provisional patent application No. 61/843,915, filed on Jul. 9, 2013; all of which are hereby incorporated by reference in their entirety.

### FIELD

The present invention is related to the security of electronic devices and systems.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

Some activities may be privileged, or may require authentication of the user in order to ensure that only an authorized user engages in the activity. For example, a user may be required to enter a username and a password in order to access an email account, or in order to access an online banking interface or website.

### SUMMARY

The present invention may include, for example, systems, devices, and methods for detecting the identity of a user of an electronic device; for determining whether or not an electronic device is being used by a fraudulent user or by a legitimate user; and/or for differentiating among users of a computerized service or among users of an electronic device.

Some embodiments of the present invention may comprise devices, systems, and methods of detecting user identity, differentiating between users of a computerized service, and detecting a possible attacker.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements or components. The figures are listed below.

FIG. 1A is a schematic block-diagram illustration of a system, in accordance with some demonstrative embodiments of the present invention;

FIG. 1B is a schematic block-diagram illustration of a system, in accordance with some demonstrative embodiments of the present invention;

FIG. 2 is a schematic block-diagram illustration of a fraud detection sub-system, in accordance with some demonstrative embodiments of the present invention;

FIG. 3 is a schematic block-diagram illustration of another fraud detection sub-system, in accordance with some demonstrative embodiments of the present invention; and

FIG. 4 is a schematic block-diagram illustration of still another fraud detection sub-system, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Applicants have realized that when a user is entering a value, moving between fields in a form or web-page, or otherwise navigating inside a web-page or a mobile application, there may often be more than one way to carry out the same activity or to achieve the same result or to complete the same goal. The way in which a user's mind perceives a task corresponds to a Cognitive Choice of that particular user.

Applicants have further realized that cyber-criminals typically demonstrate cognitive choices that are unlikely for regular (authorized, legitimate, non-fraudulent) users to conduct. For example, Applicants have realized that when transferring (wiring) money through an online service (e.g., a banking website or a banking application, or a banking web-based interface), cyber-criminals who operate in the victim's account after gaining illegal access may often avoid typing the amount of money to be transferred or wired; and instead cyber-criminals may “paste” the amount of money after they “copy” it as a string from a pre-defined instructions list or data-sheet that they (or someone else) had prepared. Such behavior is very rarely observed in genuine (legitimate, authorized) money transfers or wire transfers, performed by authorized users, who often manually type the amount of money to be transferred or wired, and never or rarely do they perform copy-and-paste operations in order to fill-in the crucial data-item of the amount to be transferred.

Similarly, when setting up multiple new accounts based on synthetic identities or stolen identities or other fake data, cyber-criminals may often copy-and-paste the applicant name (or the beneficiary name, or the funds recipient name, or the like) from a ready, previously-prepared list or data-sheet or spreadsheet; and this reflects another cognitive choice that is not likely to occur when a legitimate (authorized) user creates or operates the online account.

Other types of cognitive choices may be indicative of genuine, authorized and/or legitimate activity of a user, and may indicate that the activity is non-fraudulent. For example, the utilization of auto-complete of a password or a username (e.g., in a form, or a web-form or web-interface) instead of typing such data-items (and instead of copy-and-paste operations) may indicate a legitimate or authorized user, since a fraudster may either type the password or paste it from a list of victim data.

Similarly, the use of copy-and-paste operations in certain particular fields in a form or a screen, but not in other particular fields in the same form or screen (or in the same application or website), may be indicative of genuine user activity. For example, copying-and-pasting a 16-digit bank sort code, but also manually typing the account number and beneficiary name, may be indicative of legitimate user activity; whereas, a fraudster is more likely to copy-and-paste the data into all of these fields.

The present invention may thus track the user's cognitive choices, as they are reflected in user interactions, input and/or output, and may identify occurrences or sequences that are indicative of criminal behavior or criminal intent or fraudulent intent, as well as sequences that are indicative of genuine (or legitimate, or authorized) behavior or activity. Accordingly, even if there is no previously-generated user-specific behavioral profile for a given user (e.g., for the currently-monitored user), the system may still find evidence in the communication session itself that may increase or decrease the assessed risk or fraud with regard to the specific user who engages in the current specific session of interactions.

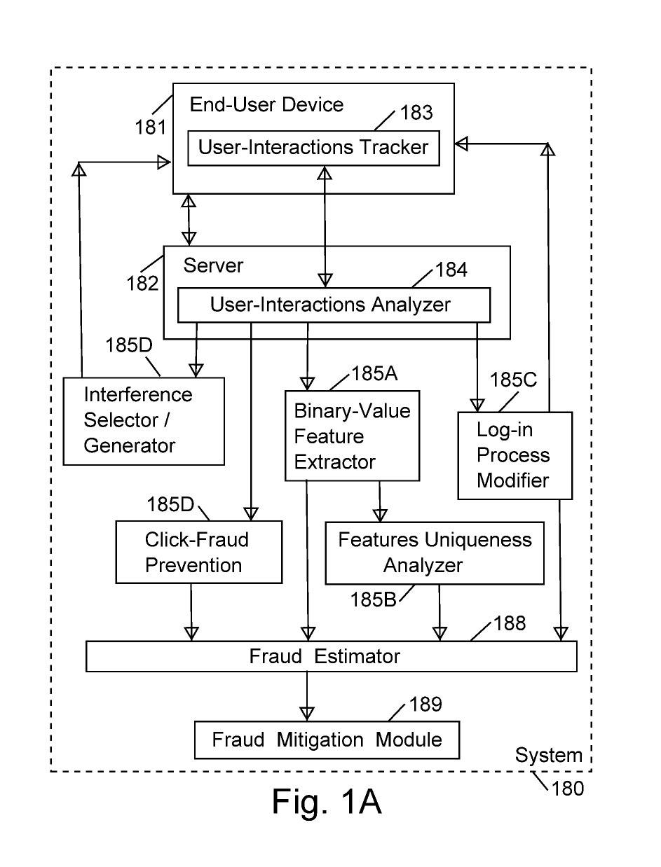

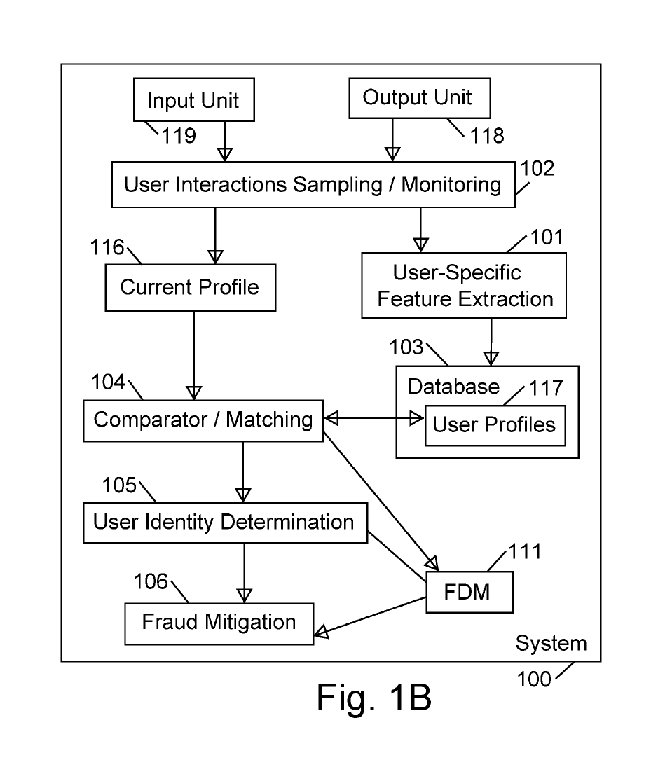

Reference is made to FIG. 1A, which is a schematic block-diagram illustration of a system 180 in accordance with some demonstrative embodiments of the present invention. System 180 may comprise, for example, an end-user device 181 able to communicate with a server 182 of a computerized service. End-user device 181 may comprise a user-interactions tracker 183, for example, implemented as JavaScript code included in (or triggered from) HTML page(s) that are served by server 182 to a Web-browser of end-user device 181. User-interactions tracker 183 may track and log locally all the user interactions that are performed via mouse, keyboard, touch-screen, and/or other input unit(s). User-interactions tracker 183 may send or upload the user-interactions data to server 182, where a user-interactions analyzer 184 may analyze and process such data. Multiple modules or sub-modules may operate to deduce or determine or estimate fraud-related or threat-related parameters, based on analysis of the user-interactions data. For example, a data-entry scorer 185A, a typing-rate scorer 185B, a user-maneuvering scorer 185C, a deletion-based scorer 185D, and a user-familiarity scorer 185E, may operate to estimate threat-levels or fraud-scores that are associated with particular interactions or sets of interactions, as described herein. A fraud estimator 188 may utilize the weighted outputs of these modules, to estimate an aggregated threat-level or fraud-score associated with the particular user or session or account; and to accordingly trigger a fraud mitigation module 189 to perform one or more fraud mitigation operations.

Reference is made to FIG. 1B, which is a schematic block-diagram illustration of a system 100 in accordance with some demonstrative embodiments of the present invention. System 100 may comprise, for example, an input unit 119, an output unit 118, a user interactions sampling/monitoring module 102, a user-specific feature extraction module 101, a database 103 to store user profiles 117, an ad-hoc or current user profile 116, a comparator/matching module 104, a user identity determination module 105, a Fraud Detection Module (FDM) 111, and a fraud mitigation module 106.

System 100 may monitor interactions of a user with a computerized service, for example, user interactions performed via an input unit 119 (e.g., mouse, keyboard, stylus, touch-screen) and an output unit 118 (e.g., monitor, screen, touch-screen) that the user utilizes for such interactions at the user's computing device (e.g., smartphone, tablet, laptop computer, desktop computer, or other electronic device). For example, a user interactions monitoring/sampling module 102 may monitor all user interactions via the input unit 119 and/or the output unit 118; and may record, log, track, capture, or otherwise sample such user interactions; and/or may otherwise collect user interaction data.

In a demonstrative implementation, for example, an end-user may utilize a computing device or an electronic device in order to launch a Web browser and browse to a website or web-based application of a computerized service (e.g., a banking website, a brokerage website, an online merchant, an electronic commerce website). The web-server of the computerized service may serve code, for example HTML code, that the Web browser of the end-user device may parse and may display and/or execute. In accordance with the present invention, for example, a JavaScript code or code-portion may be served to the Web-browser of the end-user device; or may otherwise be “called from” or loaded from an HTML page that is served to the end-user device. The JavaScript code may operate as a “silent key-logger” module, and may monitor an track and log all the user interactions via keyboard, mouse, touch-screen, and/or other input units, as well as their timing; and may write or upload or send such information to the web-server or to a third-party server in which the user interactions monitoring/sampling module 102 may reside. In some embodiments, such “silent key-logger” may be implemented such that it logs or records or stores or uploads to the server, or analyzes, only anonymous data, or only data that excludes the actual content of user interactions, or only data that on its own does not enable identification of the user or of the content that the use types; e.g., by logging or storing only the data-entry rate or timing, or the key-presses rate or timing, and while not storing (or while discarding) the actual key-presses or content types; for example, logging and storing that the user typed eight characters in two seconds, rather than logging and typing that the user types the word “Jonathan” in two seconds. The data describing the user interactions may be sent or uploaded, for example, every pre-defined time interval (e.g., every second, or every 3 or 5 or 10 seconds), or once a buffer of interactions is filled (e.g., once 20 keystrokes are logged; once 6 mouse-clicks are logged). Other suitable methods may be used to monitor and log user interactions.

The user interaction data may enable a user-specific feature extraction module 101 to extract or estimate or determine or calculate user-specific features that characterize the interaction and which are unique to the user (or, which are probably unique to the user). The user-specific feature extraction module 101 may store in a database 103 multiple user profiles 117, corresponding to various users of the computerized service. A user may have a single stored profile 117; or a user may have multiple stored profiles 117 that correspond to multiple usage sessions of that user (e.g., across multiple days; or across multiple usage sessions that begin with a log-in and end with a log-out or a time-out).

Once a user accesses (or attempts to access) the computerized service, and/or during the access of the user to the computerized service, the user interaction monitoring/sampling module 102 may monitor or sample the current user interactions; and the user-specific feature extraction module 101 may optionally create a current or ad-hoc user profile 116 that characterizes the user-specific features that are currently exhibited in the current session of user interactions.

A comparator/matching module 104 may compare or match, between: (i) values of user-specific features that are extracted in a current user session (or user interaction), and (ii) values of respective previously-captured or previously-extracted user-specific features (of the current user, and/or of other users, and/or of pre-defined sets of values that correspond to known automated scripts or “bots”). In some implementations, the comparator/matching module 104 may compare between the current ad-hoc user profile 116, and one or more previously-stored user profiles 117 that are stored in the database 103.

If the comparator/matching module 104 determines that one or more features, or a set of features, that characterize the current interaction session of the current user, does not match those features as extracted in previous interaction session(s) of that user, then, a possible-fraud signal may be generated and may be sent or transmitted to other modules of the system 100 and/or to particular recipients.

Additionally or alternatively, the comparator/matching module 104 may compare the features characterizing the current session of the current user, to features characterizing known automatic fraudulent mechanisms, known as malware or “bot” mechanisms, or other pre-defined data, in order to determine that, possibly or certainly, the current user is actually a non-genuine user and/or is accessing the service via a fraudulent mechanism.

In some embodiments, the comparator/matching module 104 may comprise, or may operate in association with, a Fraud Detection Module (FDM) 111, which may comprise (or may be implemented as) one or more sub-modules, as described herein.

In some embodiments, the output of the comparator/matching module 104 may be taken into account in combination with other information that the fraud detection module 111 may determine to be relevant or pertinent, for example, security information, user information, meta-data, session data, risk factors, or other indicators (e.g., the IP address of the user; whether or not the user is attempting to perform a high-risk activity such as a wire transfer; whether or not the user is attempting to perform a new type of activity that this user did not perform in the past at all, or did not perform in the past 1 or 3 or 6 or 12 months or other time-period; or the like).

The combined factors and data may be taken into account by a user identity determination module 105, which may determine whether or not the current user is a fraudster or is possibly a fraudster. The user identity determination module 105 may trigger or activate a fraud mitigation module 106 able to perform one or more fraud mitigating steps based on that determination; for example, by requiring the current user to respond to a challenge, to answer security question(s), to contact customer service by phone, to perform a two-step authentication or two-factor authentication, or the like.

System 100 and/or system 180 may be implemented by using suitable hardware components and/or software modules, which may be co-located or may be distributed over multiple locations or multiple devices. Components and/or modules of system 100 and/or system 180 may interact or communicate over one or more wireless communication links, wired communication links, cellular communication, client/server architecture, peer-to-peer architecture, or the like

Some embodiments of the present invention may enable detection or estimation of criminal intent (or fraudulent intent, or criminal activity, or unauthorized computerized activity or transactions) based on identification and analysis of Cognitive Choices that are reflected in user interactions.

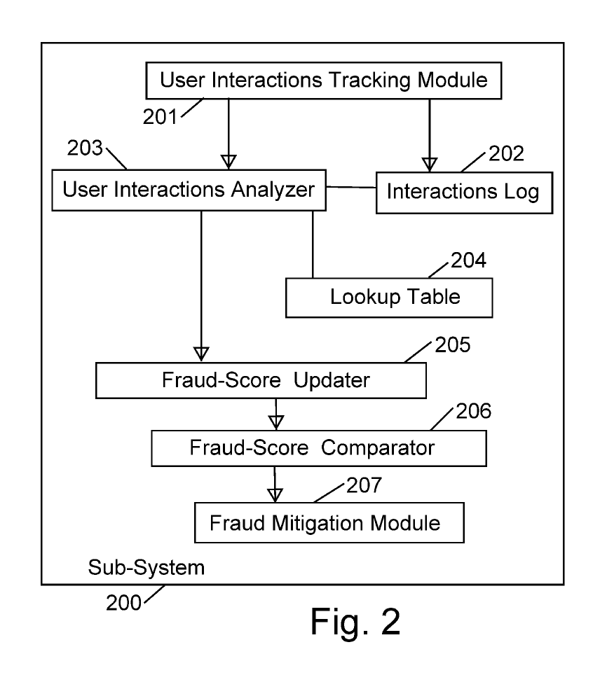

Reference is made to FIG. 2, which is a schematic block-diagram illustration of a fraud detection sub-system 200 in accordance with some demonstrative embodiments of the present invention. For example, sub-system 200 may operate to detect or to estimate, for example: fraud, fraud attempts, fraudulent computerized operations, unauthorized computerized operations, computerized operations that breach or violate a law or a regulation or policy or terms-of-use or an intended use of a service or website or application, or fraudulent activity. Sub-system 200 may further operate to distinguish or differentiate among users (or to detect fraud) based on an analysis of cognitive choices that the user(s) perform and that are reflected in the computerized device or system or service. Sub-system 200 may be implemented as part of, or as a sub-module of, the fraud detection module 111 of FIG. 1B, the system 100 of FIG. 1B, the system 180 of FIG. 1A, the fraud estimator 188 of FIG. 1A, and/or other suitable systems or modules.

In some embodiments, sub-system 200 may comprise a user interaction tracking module 201, which may track the user interactions (e.g., keyboard presses, mouse-clicks, mouse-movements, touch-screen taps, and/or other user gestures) when the user interacts with a computerized service via an electronic device (e.g., desktop computer, laptop computer, tablet, smartphone, or the like). The user interaction tracking module 201 may observe and/or record and/or log all such user interactions, and may optionally store them in an interactions log 202 or other database or repository.

In some embodiments, a user interactions analyzer 203 may review the tracked user interaction, in real time, or substantially in real time (e.g., within one second or within three seconds of the occurrence or completion of an interaction), or at pre-defined time intervals (e.g., every ten seconds, every 60 seconds), or at pre-defined triggering events (e.g., upon clicking of a “submit” button or a “confirm” button of an online form), or in retrospect (e.g., once a day in retrospect for all the daily interactions that reflect transactions that are in a pipeline for review prior to execution; or as part of a post-action audit process or crime investigation process). The user interactions analyzer 203 may look for a particular user interaction, or for a set or sequence or group or batch of consecutive user interactions, or for a set or sequence or group or batch of non-consecutive user interactions, that are pre-defined in the system as indicative of possible fraud activity (or alternatively, as pre-defined in the system as indicative of legitimate non-fraudulent activity).

For example, in accordance with some demonstrative embodiments of the present invention, a pre-populated lookup table 204 may be used by the user interactions analyzer 203 in order to detect or to estimate fraud, or conversely in order to reassure the system that the user is indeed a legitimate user. For example, each row in the lookup table 204 may correspond to a GUI element, or to a particular type of user interaction; and each such row may indicate whether a particular type of engagement with that GUI element (or with that type of user interaction) is indicative or fraud, or of authorized usage (and in some implementations: or if such interaction is “neutral” and indicates neither fraud nor legitimate usage). A demonstrative portion of such lookup table is shown herein as Table 1, with regard to a particular, single, type of user interaction:

TABLE 1

| User Interaction: | Indicative Of: |
|---|---|
| Manual typing of wire transfer amount | Legitimate User |
| into the “amount to transfer” field | |
| Copy-and-paste of a numerical string | Attacker |
| into the “amount to transfer” field | |

In another demonstrative implementation, lookup table 204 may store data relating to multiple different fields in the same form or screen, or in the same application or group of pages of the same application (and not only related to the same data field); for example, as demonstrated in Table 2:

TABLE 2

| User Interaction: | Indicative Of: |
|---|---|
| Manual typing of username | Legitimate User |
| into the “username” field | |
| Copy-and-paste of username | Attacker |
| into the “username” field | |
| Manual typing of password | Legitimate User |
| into the “password” field | |
| Copy-and-paste of password | Attacker |
| into the “password” field | |

In another demonstrative implementation, lookup table 204 may store data relating to multiple different fields that are taken in combination with each other as a batch; for example, as demonstrated in Table 3:

TABLE 3

| Multiple-Field User Interaction: | Indicative Of: |
|---|---|
| Manual typing of username | Legitimate User |
| and also manual typing of password | |
| Copy-and-paste of username | Attacker |
| and also copy-and-paste of password | |
| Copy-and-paste of username | Legitimate User |
| and also manual typing of password | |
| Manual typing of username | Legitimate User |
| and also copy-and-paste of password | |

In another implementation, lookup table 204 may store data relating to multiple different fields that are taken in combination with each other as a batch, in a manner that allows for certain combinations to be indicative of an attacker, whereas other combinations may be indicative of a legitimate user, whereas still other combinations may be regarded as “neutral” and may be indicative of neither an attacker nor a legitimate user; for example, as demonstrated in Table 4:

TABLE 4

| Multiple-Field User Interaction: | Indicative Of: |
|---|---|
| Manual typing of username | Legitimate User |
| and also manual typing of password | |
| Copy-and-paste of username | Attacker |
| and also copy-and-paste of password | |
| Copy-and-paste of username | Neutral |
| and also manual typing of password | |
| Manual typing of username | Neutral |
| and also copy-and-paste of password | |

In another implementation, lookup table 204 may store data relating to multiple different fields that are taken in combination with each other as a batch, in a manner that allows for certain combinations to be indicative of an attacker; for example, as demonstrated in Table 4:

TABLE 5

| Multiple-Field User Interaction: | Indicative Of: |
|---|---|
| Manual typing of beneficiary name | Legitimate User |
| and also | |
| manual typing of transfer amount | |
| and also | |
| copy-and-paste of bank routing number | |
| Copy-and-paste of beneficiary name | Attacker |
| and also | |
| copy-and-paste of transfer amount | |
| and also | |
| copy-and-paste of bank routing number | |
| Manual typing of beneficiary name | Attacker |
| and also | |
| copy-and-paste of transfer amount | |
| and also | |
| copy-and-paste of bank routing number | |

In some embodiments, the user interactions analyzer 203 may operate in conjunction with a fraud-score updater 205, which may store and update a score indicating the likelihood that the current user (e.g., the user who is currently engaging or interacting with the online service; and/or the user who is currently logged-in to the online service) is an unauthorized attacker. For example, in a demonstrative implementation, the fraud-score may be reset to zero upon commencement of an access to the computerized service (e.g., upon finishing the log-in process; or earlier, immediately upon accessing the online service or the computerized service and even prior to entering any log-in credentials). Optionally, the lookup table 204 may further comprise a fraud-score increment, indicating the number of points that should be added to (or reduced from) the fraud-score upon detection of a particular user interaction.

For example, the initial fraud-score may be set to zero. Then, the user interactions analyzer 203 may detect that the user performed copy-and-paste of a string into the Username field of the log-in form; this operation may be associated (e.g., in the lookup table 204) with an increase of 5 points of fraud-score; and the fraud-score updater 205 may thus increase the fraud-score from 0 points to 5 points. It is clarified that the lookup table 204, or other suitable formula or mechanism, may be utilized in order to associate each detected risk with a change in fraud-score (or in threat-level); and the fraud-score updater 205 may take into account such fraud-score modifiers, based on such lookup table 204 or based on other parameters or formulas or weighting-formulas that indicate fraud-score modifications.

Then, the user interactions analyzer 203 may detect that the user performed copy-and-paste of a string into the Password field of the log-in form; this operation may be associated (e.g., in the lookup table 204) with an increase of only 2 points of fraud-score (for example, because some legitimate users store their passwords in a file or list); and the fraud-score updater 205 may thus increase the fraud-score from 5 points to 7 points.

Then, the user interactions analyzer 203 may detect that the user performed manual typing of an amount of money to be transferred in a requested wire transfer. Such manual typing (and not copy-and-paste operation) in the particular field of amount of money to be transferred, may be associated (e.g., in the lookup table 204) with no change in the fraud-score; and the fraud-score updater 205 may thus maintain the fraud-score at 7 points, without modifications. In other implementations, such manual typing of this data-item may be associated with a decrease in the fraud-score; and the fraud-score updater 205 may thus decrease the fraud-score accordingly.

Then, the user interactions analyzer 203 may detect that the user performed copy-and-paste of a string into the Beneficiary Account field of the log-in form; this operation may be associated (e.g., in the lookup table 204) with an increase of 4 points of fraud-score; and the fraud-score updater 205 may thus increase the fraud-score from 7 points to 11 points.

A fraud-score comparator 206 may dynamically check the current value of the fraud-score, against a pre-defined threshold value. For example, it may be pre-defined in the system that a fraud-score of 10-or-more points is a first threshold; and that a threshold of 15-or-more points is a second threshold. The fraud-score comparator 206 may determine that the current value of the fraud-score, which is 11 points, is greater than the first threshold; and may trigger or activate a fraud mitigation module 207 to perform one or more pre-defined operations for this level of fraud-score (e.g., require the user to perform two-factor authentication or two-step authentication). Optionally, the fraud-score comparator may continue to monitor the dynamically-updating fraud-score, and may take different actions based on the current fraud-score; for example, detecting that the current fraud-score is also greater than the second threshold value, and triggering the fraud mitigation module to perform one or more other operations (e.g., requiring the user to actively call a telephone support line or a fraud department of the computerized service).

Some embodiments of the present invention may detect or estimate fraud (or fraudulent activity, or a fraudulent user) based on estimating the familiarity and/or the non-familiarity of the user with one or more data-items (or portions) of the inputted content.

Applicants have realized that a legitimate human user, who interacts with a particular online service or activity (e.g., an online banking interface, or online banking web-site or web-page), is typically familiar or very familiar with particular portions of the inputted content, and is typically less familiar or non-familiar with other particular portions of the inputted content.

For example, a legitimate human user may be familiar or very familiar with his username and/or password, or with names of beneficiaries or payees for wire transfer, or with names of stocks that he traded in the past or that he often trades; and thus he may type these content items rapidly and/or smoothly and/or continuously and/or without performing delete operations. Whereas, a legitimate human user may typically be less familiar with other content items or data-items that he may need to input, for example, account number and/or banking routing number of a beneficiary or payee for a wire transfer, or an address or account number of a payee or beneficiary; and a legitimate human user may typically type or enter these content items less smoothly and/or more slowly and/or while using delete operations.

Applicants have further realized that in contrast, a “fraudster” or an unauthorized user or an attacker may be generally unfamiliar with all or most of the content items or data-items that need to be inputted; and therefor may be characterized by having the same speed or similar speed or uniform speed or generally-constant speed (or same frequency, or uniform frequency, or generally-constant frequency, or similar frequency) of inputting all or most of the required content-items or data-items.

The present invention may thus track and log and monitor, and may process and analyze, the rate and/or speed and/or frequency at which the user inputs data-items and/or content items, in order to differentiate between a legitimate (authorized) human user and an attacker or unauthorized human user (or “fraudster”).

In a demonstrative example, the system may determine that a user that enters his username and password quickly, and then enters a beneficiary name quickly, and then enters the beneficiary bank account slowly, may be characterized as a legitimate (authorized human user); whereas, in contrast, a user who enters all the above-mentioned content items slowly, or a user that enters all the above-mentioned content at approximately the same rate or speed, may be characterized as a fraudulent user or an attacker.

In accordance with the present invention, similar data-entry rate changes (or generally-consistent data-entry rate) may be detected (e.g., by a data entry rate analyzer 303, as described herein) and may be utilized for fraud detection, with regard to other operations during a communication session or during an interaction session or usage session; for example, performing of online operations or actions, performing mouse-clicks, typing, movement among fields or tabs, or the like.

Some embodiments may utilize a user differentiation rule, according to which: a user who enters data (or types data) into all fields at a generally constant or fixed rate or speed, is possibly an attacker and not an authorized user; since a regular or authorized user is typically not equally familiar or not equally intimate with the data-items of the various fields. For example, an authorized user is typically more familiar with certain data-items (e.g., name, home address, username), while he is also less familiar with certain other data-items (e.g., the routing number of his bank account; the routing number of a beneficiary for wire transfer; the address of a payee or an intended beneficiary of payment). Such rule(s) may be used by the system in order to differentiate between an authorized user and an attacker.

Some embodiments may utilize a user differentiation rule, according to which: a genuine user typically does not make a typographical error when writing his own name, and therefore, a genuine user does not delete characters when typing his own name. In contrast, an attacker is less familiar with the name of the user being impersonated by the attacker, and may make a typographical error when typing the name, and may need to use delete operation(s) during the entry of the name of the user. Such rule(s) may be used by the system in order to differentiate between an authorized user and an attacker.

Some embodiments may utilize a user differentiation rule, according to which: a genuine user (non-attacker), who creates a new account at a computerized service for the first time (e.g., creates a new online account for online banking or online brokerage or credit card management, or the like), is typically unfamiliar with the flow and/or content of screens or pages that are presented to him in sequence as part of the account-creation process; whereas, in contrast, an attacker is more likely to be more familiar with the flow and/or content of screens or pages that are presented to him in sequence as part of the account-creation process (e.g., because the attacker had already attacked that computerized service recently or in the past; or since the attacker had already spent time preparing for his cyber-attack and had already reviewed the screens or pages that are part of the account-creation process). Accordingly, a genuine user will most likely exhibit the same speed or data-entry rate when measured across multiple screens or pages of the account-creation process, since he is generally unfamiliar with all of them, and his data-entry speed or rate would most likely be relatively low (e.g., below a pre-defined threshold of characters-per-second or fields-per second); whereas in contrast, an attacker would most likely be more familiar with such screens or pages of the account-creation process, and his data-entry rate across multiple screens or pages would be relatively high (e.g., above a pre-defined threshold of characters-per-second or fields-per-second). Such rule(s) may be used by the system in order to differentiate between an authorized user and an attacker.

In some embodiments, an “invisible challenge” may be generated and used in order to further fine-tune the differentiation between a genuine new user who creates a new online account, and an attacker who creates a new online account. For example, the account creation-process may comprise three screens or three pages: a first screen requesting the user to define a username, a password, and security questions; a second screen requesting the user to enter his name and contact information; and a third screen requesting the user to select or configure preferred settings for the online account being created. In accordance with the present invention, the computerized system may always commence the account-creation process with the first screen; but then, may randomly or pseudo-randomly (or, when other possible-fraud indication(s) are triggered) may switch or swap the order of (or may “shuffle” the order of) the next account-creation screens or pages; such that, for example, the above-mentioned third screen (settings configuration) would be presented to the user prior to presenting to the user the above-mentioned second screen (personal information). The system may utilize a rule representing that a genuine new user would not be “surprised” by this change-in-order, since it is his first time of engaging with the account-creation process, and such genuine user would not exhibit any different behavior, and would maintain his regular typing-speed or data-entry speed, and would not exhibit delays or “correction operations” (e.g., would not click on the Back button of the browser or the account-creation process); whereas in contrast, an experienced attacker (even with relatively little experience) would be “surprised” by this change-in-order, may reduce his typing-speed, may delay his response(s), and/or may attempt to perform such “correction operations”. Other modifications may be introduced or injected into the account-creation process, in order to elicit delays or other responses from an attacker; for example, switching or swapping or “shuffling” the order in which fields are presented within a form or page or screen; changing the on-screen location of GUI elements (e.g., the Submit button or the Next/Back buttons); adding a redundant question that is not required for the account-creation process (e.g., “How did you hear about us?”); or the like. A genuine user would not experience any “surprising changes” here, and would not modify his data-entry patterns; whereas an experienced attacker would be surprised and would exhibit changes in his data-entry patterns or speed, in his navigation or interactions, or the like. Such rule(s) may be used by the system in order to differentiate between an authorized user and an attacker.

In some embodiments, intentional or random or pseudo-random changes or interferences, may be introduced to inter-page navigation mechanisms that are utilized by the user within a single page or screen. In a first example, the system may observe that a particular user is utilizing the Tab key frequently in order to move between fields in a form; and therefore, after a few such identified utilizations of the Tab key, the system may intentionally introduce a Tab key related interference, for example, which causes the pressing of the Tab key to move to a non-consecutive field, or to move the cursor to a random field in the form, or to maintain the cursor at the same field even though the Tab key is pressed; thereby causing a “surprise element” to the user, and enabling the system to gauge or to estimate the true level of familiarity of the user with the screen or the application.

In some embodiments, the type of the computerized service, or the type of transaction or operation that the user is attempting to perform, may have a weight as a contributing factor when determining whether the level of familiarity indicates a genuine user or an attacker. In some embodiments, for example, the determination whether the user is a genuine (authorized) user or a cyber-attacker, may take into account one or more of the following factors: (a) whether or not the user interactions indicate that the user is very familiar with this computerized service; (b) whether or not the user interactions indicate that the user is very familiar with the particular type of transaction (e.g., wire transfer; online purchase) that the user is attempting to perform at the computerized service; (c) whether the user is “generally surprised by”, or is “generally indifferent to”, random or intentional modifications to the regular flow of the application or to the regular behavior of application-elements or GUI elements; (d) whether the computerized service being examined is a type of computerized service that users in general frequently visit and thus are expected to show high level of familiarity (e.g., banking website), or in contrast, a type of computerized service that users are not expected to visit frequently and thus are expected to show low level of familiarity (e.g., online vendor or wedding rings); (e) whether the particular operation that the user is attempting to perform, at the computerized service, is an operation that most users are expected to be very familiar with (e.g., reviewing paid checks in a bank account online), or is an operation that most users are expected to be less familiar with (e.g., requesting to add a power-of-attorney to a bank account).

In a demonstrative example, if the analysis of user interactions indicate that the user is very familiar with the website, and the website is a vendor of wedding rings (e.g., a transaction that a typical user performs rarely, or once in his life, or few times in his life), and if the user appears to be “surprised” (based on his user interactions) to small modifications or interference that are injected into the GUI or the flow of the service, then the user may be estimated to be a cyber-attacker. In contrast, introduction an interference to field-navigation in a checks-reviewing screen of a bank account online service, even if such introduction causes an identifiable “surprise” reaction at the user, may not lead to categorization of the user as an attacker; since many users may be highly-familiar with the checks-reviewing screen of a popular banking service. The present invention may thus allocate different weights to the above mentioned factors (a) through (e), and/or other relevant factors, in order to determine or to estimate, based on their weighted values, whether the user is an authorized user or a cyber-attacker.

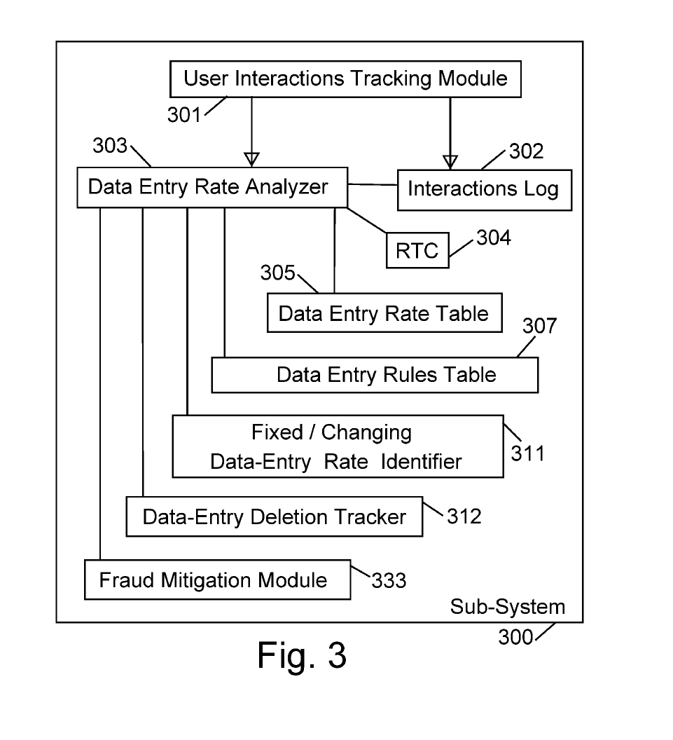

Reference is made to FIG. 3, which is a schematic block-diagram illustration of a fraud detection sub-system 300 in accordance with some demonstrative embodiments of the present invention. Sub-system 300 may operate to detect or to estimate, for example: fraud, fraud attempts, fraudulent computerized operations, unauthorized computerized operations, computerized operations that breach or violate a law or a regulation or policy or terms-of-use or an intended use of a service or website or application, or fraudulent activity. Sub-system 300 may further operate to distinguish or differentiate among users (or to detect fraud) based on analysis and/or estimation of the level of familiarity (or non-familiarity) of a user relative to one or more data-items or inputted-data that are entered by the user at a computerized device or towards a computerized system or computerized service. Sub-system 300 may be implemented as part of, or as a sub-module of, the fraud detection module 111 of FIG. 1B, the system 100 of FIG. 1B, the system 180 of FIG. 1A, the fraud estimator 188 of FIG. 1A, and/or other suitable systems or modules.

Sub-system 300 may comprise a user interaction tracking module 301, which may track the user interactions (e.g., keyboard presses, mouse-clicks, mouse-movements, touch-screen taps, and/or other user gestures) when the user interacts with a computerized service via an electronic device (e.g., desktop computer, laptop computer, tablet, smartphone, or the like). The user interaction tracking module 301 may observe and/or record and/or log all such user interactions, and may optionally store them in an interactions log 302 or other database or repository.

Sub-system 300 may comprise a Data Entry Rate Analyzer (DERA) 303 which may analyze, calculate and/or determine the rate or speed or velocity or frequency of data entry into each field (e.g., field in a fillable form) or other GUI element of the computerized service. DERA 303 may operate in real-time, for example, operable associated with a Real-Time Clock (RTC) 304; and/or DERA 303 may operate by analyzing freshly-stored or recently-stored or previously-stored data recorded in the interactions log 302.

In a demonstrative implementation, DERA 303 may generate, construct, update and/or populate a Data Entry Rate Table (DERT) 305; which may have structure or format similar to, for example, the demonstrative Table 6:

TABLE 6

| | | | Data Entry Rate | |
|---|---|---|---|---|
| | Characters | Time Period | (CPS = characters | Deleted |
| Field | Typed | of Typing | per second) | Characters |
| Username | 12 | 3.0 seconds | 4.0 CPS | 0 |
| Password | 16 | 4.1 seconds | 3.9 CPS | 0 |
| Home Address | 25 | 6.1 seconds | 4.1 CPS | 0 |
| Beneficiary | 15 | 3.9 seconds | 3.8 CPS | 1 |
| Name | | | | |
| Beneficiary | 9 | 4.5 seconds | 2.0 CPS | 1 |
| Account | | | | |

Table 6 may demonstrate the analyzed and stored data corresponding to a legitimate (non-attacker) user. The user may be very familiar with his own username and password, as well as his home address and the beneficiary name (e.g., for a wire transfer), and thus may have a high and generally-similar data entry rate for these fields (around 4.0 CPS or characters per second). In contrast, the legitimate user is not too familiar with the Beneficiary Account number, and he enters that data using a slower rate of only 2.0 CPS (e.g., due to the need to manually copy the data-item from a printed bill or statement or invoice). The data entry rate is not fixed and not constant, and therefore, in accordance with some embodiments of the present invention, it indicates that the user is closely familiar with the data for some fields, but is unfamiliar with the data for other fields. In accordance with some demonstrative embodiments of the present invention, this may be reinforced by analyzing the number of deletion operations that the user performed when entering each data item: for example, showing zero deletions for his most familiar fields, and showing one (or more) deletions in fields that the user is less familiar with their content.

In contrast, Table 7 demonstrates data stored and/or processed and/or analyzed, which may correspond to user interactions performed by an attacker which enters the same data-items into the same fields:

TABLE 7

| | | | Data Entry Rate | |
|---|---|---|---|---|
| | Characters | Time Period | (CPS = characters | Deleted |
| Field | Typed | of Typing | per second) | Characters |
| Username | 12 | 3.4 seconds | 3.5 CPS | 0 |
| Password | 16 | 4.4 seconds | 3.6 CPS | 0 |
| Home Address | 25 | 7.3 seconds | 3.4 CPS | 0 |
| Beneficiary | 15 | 4.4 seconds | 3.4 CPS | 0 |
| Name | | | | |
| Beneficiary | 9 | 2.5 seconds | 3.6 CPS | 0 |
| Account | | | | |

As demonstrated in Table 7, the data entry rate of this user is generally constant at around 3.5 CPS, indicating that this user is possibly an attacker that has the same level of familiarity (or non-familiarity) with all the data-items being entered, regardless of whether the data-item is of a type that the user is usually using often and can memorize easily (e.g., username) or of a type that the user rarely uses and rarely memorizes (e.g., beneficiary account number). Similarly, the Deletions analysis shows that the same degree of deletions (for example, no deletions at all) occurred during entry of all the data-items; again indicating that this is possibly an attacker who carefully copies data from a prepared sheet or file or list, and thus allowing the system to generate a cyber-attack notification or alert, and to trigger the activation of one or more fraud mitigation steps.

The DERA 303 may analyze the data of DERT 305 relative to one or more pre-defined data-entry rules, which may be stored or represented in a suitable manner or structure, for example, by utilizing a data-entry rules table 306; which may be similar to Table 8:

TABLE 8

| Data Entry Characteristic: | Indicative Of: |
|---|---|
| Generally-constant data entry rate | Attacker |
| Changing data entry rate | Legitimate User |
| No deletions | Attacker |
| Deletions below a threshold value | Attacker |
| Deletions above a threshold value | Legitimate User |

The data in Table 8 may be generated or may be defined with regard to all the fields in a form or a screen or a web-page or application-page; or with regard to a subset or group of fields within a single screen or web-page or application-page; or with regard to multiple fields that are displayed across multiple screens or multiple web-pages or multiple application-pages.

The DERA 303 may optionally be implemented by using (or may be associated with) one or more sub-modules; for example, a fixed/changing data-entry rate identifier 311, which may be responsible for tracking the data entry rate of various data items across various fields (in the same page, or across multiple pages); a data-entry deletion tracker 312, which may be responsible for tracking deletions of characters during data entry across various fields (in the same page, or across multiple pages); and/or other modules or sub-modules.

The DERA 303 and/or other such sub-modules, may trigger or may activate a fraud mitigation module 333 to perform one or more pre-defined operations based on the fraud indications that were determined; for example, to require the user to perform two-factor authentication or two-step authentication, or to require the user to actively call a telephone support line or a fraud department of the computerized service. In some implementations, the DERA 303 and/or other modules may update a fraud-score based on the possible fraud indications that were determined; and fraud mitigation operations may be triggered only when the fraud-score reaches or traverses a pre-defined threshold value.

Some embodiments of the present invention may detect, may recognize, and may then utilize for user authentication purposes or for fraud detection purposes, an analysis of user behavior with regard to particular fields or data-fields or regions of online forms or other suitable User Interface (UI) components or Graphic UI (GUI) components or elements. The analysis may pertain to, for example: various behavioral choices and UI preferences of users; handling of date entry or date field; tracking and profiling where a user clicks on a field or button as being a distinctive trait of the user; tracking post-mouse-click effect as a distinctive user trait (e.g., a user that clicks the mouse button hard, causes a greater motion of the mouse pointer during or after the click); or the like. Such behavior may be tracked by the system, and its analysis may detect user-specific characteristics that may differentiate between an authorized user of the computerized service and an attacker.

Some embodiments of the present invention may determine a user-specific trait that may assist in authenticating the user and/or in detecting an attacker, based on, for example: (a) the way in which the user typically switches between browser tabs (e.g., by clicking with the mouse on the tabs bar, or by using a keyboard shortcut such as CTRL+SHIFT); (b) the way in which the user types or enters an upper case letter or word (e.g., by clicking on CAPS lock and then typing the letter or the word, or, by holding down the SHIFT key and concurrently typing the letter); (c) the way in which the user moves between fields in an online form (e.g., by using the mouse to click on fields, or by using the TAB key to move between fields); (d) the way in which the user corrects a typographical error (e.g., by using the “Del” key or by using the “Backspace” key; by clicking consecutively several types or by doing a “sticky” click in which the key is held down for a longer time to delete several characters); (e) the way in which the user performs copy-and-paste or cut-and-paste operations (e.g., by using a keyboard shortcut such as CTRL-C, CTRL-V, CTRL-X; or by using the mouse right-click); (f) the way in which the user selects items or text (e.g., by using the mouse or using keyboard shortcuts; by double-clicking the mouse button or by mouse dragging to select); (g) the way in which the user submits a form or information (e.g., by clicking with the mouse on a Submit button displayed on the screen, or by pressing the Enter key); (h) the way in which the user scrolls a page or a list (e.g., by using the arrow keys on the keyboard; by using page-up/page-down on the keyboard; by using the Space Bar to scroll to the next page in some applications or in some websites; by using the scroll wheel of the mouse; by using the on-screen scroll bar; by using a scroll bar integrated in a touch-pad); (i) the way in which the user enters numeric data (e.g., by using the numeric pad, or the line of number keys at the top of the keyboard); and/or other user-specific traits that may be extracted or learned from observing repeated behavior and interaction of a user with an application or website or computerized service.

Some embodiments of the present invention may extract user-specific traits by observing the way in which the user typically enters a date, or enters date data. For example, the system may detect that a particular user typically enters a date by typing the numeric values on the keypad, and not on the top row of the keyboard (or vice versa); or, that a particular user enters the slash character “/” by using the keyboard and not the numeric pad (or vice versa); or that a particular user moves between date fields using the TAB key and not using a mouse click (or vice versa); or that a particular user typically uses a mouse to expose a drop-down mini-calendar matrix representation and in order to browse such mini-calendar and in order to click and select a date in the mini-calendar; or the like. These observations may be used by the system to establish a user-specific interaction trait or behavioral trait, which may subsequently be used to detect an attacker that behaves or interacts differently from the established user-specific traits of the legitimate user, when attempting to operate the online account of the legitimate user (e.g., the attacker posing as the legitimate user, during or after gaining access to the online account or to the computerized service by using the credentials of the legitimate user). Accordingly, some embodiments of the present invention may be used in order to automatically identify that a user (e.g., an attacker or a “fraudster”) is attempting to pose as (or impersonate, or “spoof”) another user (e.g., the “real” user or the genuine user).

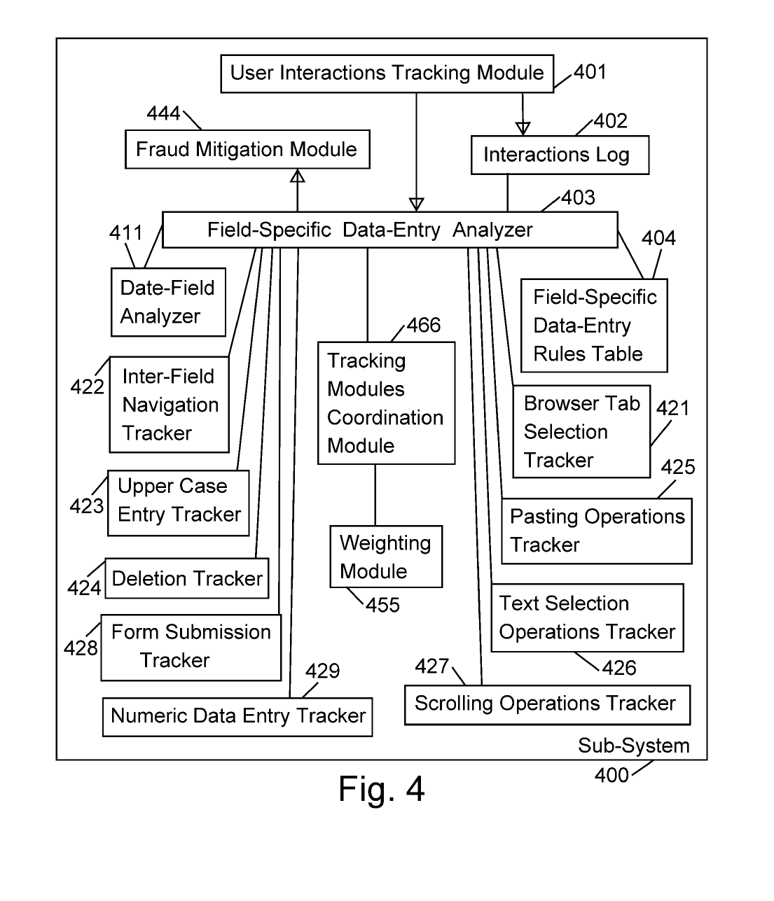

Reference is made to FIG. 4, which is a schematic block-diagram illustration of a fraud detection sub-system 400 in accordance with some demonstrative embodiments of the present invention. Sub-system 400 may operate to detect or to estimate, for example: fraud, fraud attempts, fraudulent computerized operations, unauthorized computerized operations, computerized operations that breach or violate a law or a regulation or policy or terms-of-use or an intended use of a service or website or application, or fraudulent activity. Sub-system 400 may further operate to distinguish or differentiate among users (or to detect fraud) based on analysis and/or estimation of the user behavior with regard to a particular field, or a particular type-of-field, or a particular type of data-item, that the user interacts with (or inputs data at), via a computerized device or towards a computerized system or computerized service. Sub-system 400 may be implemented as part of, or as a sub-module of, the fraud detection module 111 of FIG. 1B, the system 100 of FIG. 1B, the system 180 of FIG. 1A, the fraud estimator 188 of FIG. 1A, and/or other suitable systems or modules.

Sub-system 400 may comprise a user interaction tracking module 401, which may track the user interactions (e.g., keyboard presses, mouse-clicks, mouse-movements, touch-screen taps, and/or other user gestures) when the user interacts with a computerized service via an electronic device (e.g., desktop computer, laptop computer, tablet, smartphone, or the like). The user interaction tracking module 301 may observe and/or record and/or log all such user interactions, and may optionally store them in an interactions log 402 or other database or repository.

Field-specific data-entry analyzer 403 may track and/or analyze the manner in which the user enters data into (or interacts with) a particular field in a form; or a particular type-of-field in a form (e.g., Date field; username field; password field; beneficiary name field; beneficiary account number field; bank routing number field; or the like). Field-specific data-entry analyzer 403 may analyze user interactions, in real time and/or by reviewing the logged data that is stored in interactions log 402. Field-specific data-entry analyzer 403 may analyze such data in view of one or more pre-defined rules, which may optionally be stored or represented via a field-specific data-entry rules table 404. Field-specific data-entry analyzer 403 may generate one or more insights, for example, indication of fraud, indication of legitimate user, indication of possible fraud, or the like. Such generated indications may be used in order to construct or update a fraud-score associated with a current user or with a communication session or with a transaction; and/or may be used in order to trigger or activate a Fraud Mitigation Module 444 (e.g., requiring the user to use two-factor authentication, or to contact the fraud department by phone).

In a demonstrative implementation, the field-specific data-entry analyzer 403 may comprise, or may be associated with, one or more modules or sub-modules; for example, a Date Field analyzer 411 which may track the ongoing and/or past entry of date data to the system by a user. For example, the Date Field analyzer 411 may detect that the user who is currently logged in to a banking account, had always selected a date for wire transfer by clicking with the mouse on a drop-down mini-calendar matrix and selecting with the mouse a date in the mini-calendar; whereas, the same user is now entering the Date data (or, has just finished entering the Date data) in another manner, for example, by manually typing eight (or ten) characters via a keyboard (e.g., in the format of YYYY-MM-DD or in the format of YYYY/MM/DD, or the like). Accordingly, the Date Field analyzer 411 may trigger an indication of possible fraud, namely, that the current user is actually an attacker who enters the date manually via a keyboard, in contrast with a legitimate user who had entered the date in all previous sessions (or transactions) by selecting a date with the mouse from a drop-down mini-calendar matrix. Similarly, the Date Field analyzer 411 may detect an attacker who is entering the date via manual typing in the format of YYYY/MM/DD having the Slash character as separator; whereas all previous communication sessions of that user had receive user input of dates in the structure of YYYY-MM-DD having the Minus character as separator; thereby triggering a possible fraud indication for the current session or transaction.

Similarly, sub-system 400 may comprise other modules or sub-modules, which may analyze the tracked or recorded user interactions, in order to identify other user-specific behavior which may indicate that a current user does not match a pattern of usage that was exhibited in prior communication sessions (or usage sessions, or logged-in sessions, or transactions) of the same (e.g., currently logged-in) user.

For example, a Browser Tab Selection tracker 421 may track and/or identify the method(s) that the user utilizes in order to switch among Browser Tabs; and may compare the currently-utilized method(s) to previously-tracked user method(s) of performing this task by the same user (e.g., on the same user-account). Such methods may include, for example, (a) using a keyboard (e.g., CTRL+SHIFT); (b) using the mouse (or other pointer or pointing-device) to click on a browser tab in order to switch to it. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, an Inter-Field Navigation tracker 422 may track and/or identify the method(s) that the user utilizes in order to move or navigate or switch among Fields of a single form or screen or web-page; and may compare the currently-utilized method(s) to previously-tracked user method(s) of performing this task by the same user (e.g., on the same user-account). Such methods may include, for example, (a) using a keyboard (e.g., pressing TAB to move to the next field, or pressing SHIFT+TAB to move to the previous field); (b) using the mouse (or other pointer or pointing-device) to click on a field in order to switch to it. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, an Upper Case entry tracker 423 may track and/or identify the method(s) that the user utilizes in order to enter or to input Upper Case letter(s) and/or word(s); and may compare the currently-utilized method(s) to previously-tracked user method(s) of performing this task by the same user (e.g., on the same user-account). Such methods may include, for example, (a) pressing and depressing the CAPS lock, and then typing the letter or word as upper case; (b) holding down the SHIFT key and concurrently typing the letter(s) as upper case. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Deletion tracker 424 may track and/or identify the method(s) that the user utilizes in order to delete character(s) or words (or other text portions) in a form or page or screen or application; and may compare the currently-utilized method(s) to previously-tracked user method(s) of performing this task by the same user (e.g., on the same user-account). Such methods may include, for example: (a) using the “Del” key; (b) using the “Backspace” key; (c) pressing consecutively several types in discrete key-presses, in contrast to performing a “sticky” or continuous pressing in which the key is held down for a longer time to delete several characters; (d) using the mouse (or other pointer or pointing-device) for selecting a word or a sentence or a text-portion with the mouse, and then using the mouse (or other pointer or pointing-device) to perform a Cut operation; (e) using the mouse (or other pointer or pointing-device) for selecting a word or a sentence or a text-portion with the mouse, and then using the keyboard (e.g., the Del key, or the Backspace key, or a keyboard shortcut such as CTRL-X) to remove the selected portion. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Pasting Operations tracker 425 may track and/or identify the method(s) that the user utilizes in order to cut-and-paste or copy-and-paste data items (e.g., text, numbers) in a form or page or screen or application; and may compare the currently-utilized method(s) to previously-tracked user method(s) of performing this task by the same user (e.g., on the same user-account). Such methods may include, for example: (a) using a keyboard shortcut such as CTRL-C, CTRL-V, CTRL-X; (b) using the mouse right-click. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Text Selection Operations tracker 426 may track and/or identify the method(s) that the user utilizes in order to select (or to “paint” as selected) text or data-items in a form or page or screen or application; and may compare the currently-utilized method(s) to previously-tracked user method(s) of performing this task by the same user (e.g., on the same user-account). Such methods may include, for example: (a) using the mouse; (b) using keyboard shortcuts; (c) double-clicking the mouse button to select a word, in contrast to dragging the mouse while clicking it to select a word. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Scrolling Operations tracker 427 may track and/or identify the method(s) that the user utilizes in order to scroll through a form or list or menu or page or screen or application; and may compare the currently-utilized method(s) to previously-tracked user method(s) of performing this task by the same user (e.g., on the same user-account). Such methods may include, for example: (a) using the mouse to click on scrolling arrows; (b) using the mouse to drag a scroll-bar; (c) using a mouse-wheel to scroll; (d) using keyboard shortcuts such as Arrow Up, Arrow Down, Page-Up, Page-Down, Home, End; (e) using application-specific keyboard shortcuts, such as the Space Bar in some browsers or applications; (f) using a vertical scroll-line or scroll-regions that is incorporated into some touch-pads (e.g., located at the right side of a touch-pad of a laptop computer). Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Form Submission tracker 428 may track and/or identify the method(s) that the user utilizes in order to submit or “send” a form or query or request or command; and may compare the currently-utilized method(s) to previously-tracked user method(s) of performing this task by the same user (e.g., on the same user-account). Such methods may include, for example: (a) using the mouse to click on a “submit” button; (b) pressing the Enter or Return key on the keyboard. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

For example, a Numeric Data Entry tracker 429 may track and/or identify the method(s) that the user utilizes in order to enter numeric data or numerical values (e.g., monetary amount; telephone number; zip code; bank account number). Such methods may include, for example: (a) using a numeric key-pad that some keyboards include; (b) using the horizontal row of digit keys that appears at the top of a QWERTY keyboard. Other methods may be used, tracked, and monitored; and may be utilized in order to differentiate among users, or among a legitimate user and an attacker. In some embodiments, utilization of a method that is different from the method used in the most-recent K interactions or sessions (e.g., most recent 3 or 5 or 10 usage sessions), may indicate that the current user is an attacker.

Other suitable tracking/detection modules may be used. In some embodiments, the variety of modules may be used in an aggregate manner; for example, utilizing a Tracking Modules coordination module 466 which may ensure that only if two or more modules (or, at least K modules) report that a possible fraud is taking place (or took place), then (and only then) fraud alert may be triggered and fraud detection may be declared. In some embodiments, a weighting module 455 may optionally be used, in order to allocate different weights to the indications produced by the various modules, and in order to produce a weighted fraud-score; and if the fraud-score is greater than a pre-defined threshold value then fraud may be declared and/or fraud mitigation steps may be triggered or activated.

The present invention may differentiate or distinguish between the genuine (human) user, and a robot or a machine-operable module or function (e.g., implemented as a computer virus, a Trojan module, a cyber-weapon, or other malware) which attempts to automatically imitate or emulate or simulate movement of a cursor or other interaction with a touch-screen. For example, false identity created by automated malware may be detected by the present invention as such automated malware may lack the characterization of human (e.g., the manual activity having the particular user-specific traits, as described above).

The present invention may operate and may provide an efficient biometric or user-authentication modality, without capturing, storing, or otherwise identifying any Personally Identifiable Information (PII). For example, the present invention may be used to distinguish between a genuine user and a fraudster, without knowing any PPI of the genuine user and/or of the fraudster.

The present invention may detect correlations and extract user-specific traits based on passive data collection and/or based on active challenges. In passive data collection, the device may detect that the user is performing a particular operation (e.g., a vertical scroll gesture), and may further detect that performing this gesture affects in a user-specific way the acceleration and/or the orientation/rotation of the mobile device. In an active challenge, the device (or an application or process thereof) may actively present a challenge to the user, such as, a requirement to the user to perform horizontal scrolling, in order to capture data and detect user-specific correlation(s). The active challenge may be hidden or may be unknown to the user, for example, implemented by creating a Graphical User Interface (GUI) that requires the button to scroll in order to reach a “submit” button or a “next” button or a “continue” button, thereby “forcing” the user to unknowingly perform a particular user-gesture which may be useful for correlation detection or for extraction of user-specific traits, as described. Alternatively, the active challenge may be known to the user, and may be presented to the user as an additional security feature; for example, by requesting the user to drag and drop an on-screen object from a first point to a second point, as an action that may be taken into account for confirming user identity.

Some embodiments of the present invention may be implemented, for example, as a built-in or integrated security feature which may be a component or a module of a system or device, or may be a downloadable or install-able application or module, or plug-in or extension; or as a module of a web-site or web-page, or of a client-server system or a “cloud computing” system; or as machine-readable medium or article or memory unit able to store instructions and/or code which, when executed by the mobile device or by other suitable machine (e.g., a remote server, or a processor or a computer) cause such machine to perform the method(s) and/or operations described herein. Some units, components or modules, may be implemented externally to the user device, may be implemented in a remote server, a web server, a website or webpage, a “cloud computing” server or database, a client/server system, a distributed system, a peer-to-peer network or system, or the like.

The present invention may be used in conjunction with various suitable devices and systems, for example, various devices that have a touch-screen; an ATM; a kiosk machine or vending machine that has a touch-screen; a touch-keyboard; a system that utilizes Augmented Reality (AR) components or AR glasses (e.g., Google Glass); a device or system that may detect hovering gestures that do not necessarily touch on the screen or touch-screen; a hovering screen; a system or device that utilize brainwave analysis or brainwave control in which the user's brainwaves are captured or read and the user's brain may directly control an application on the mobile device; and/or other suitable devices or systems.

In some embodiments, the terms “rapidly” or “fast” or similar terms, may comprise, for example: at a rate or at a speed that is greater than threshold value; at a rate or at a speed that is greater than an average or a median or a most-frequent rate or speed that is associated with one or more other users (e.g., the general population; a selected group of users out of the general populations; a group of users of the same computerized service; a group of users of the particular type of transaction that is being reviewed).

In some embodiments, the term “slowly” or similar terms, may comprise, for example: at a rate or at a speed that is smaller than threshold value; at a rate or at a speed that is smaller than an average or a median or a most-frequent rate or speed that is associated with one or more other users (e.g., the general population; a selected group of users out of the general populations; a group of users of the same computerized service; a group of users of the particular type of transaction that is being reviewed).

In accordance with some embodiments of the present invention, a method may comprise: determining whether a user, who utilizes a computing device to interact with a computerized service, is (A) an authorized user, or (B) an attacker posing as the authorized user and gaining unauthorized access to the computerized service; wherein the determining comprises: tracking user interactions with the computerized service via an input unit of the computing device; analyzing the user interactions with the computerized service; based on analysis of the user interactions with the computerized service, deducing at least one of: (i) changes in data-entry rate of said user, and (ii) level of familiarity of said user with said computerized service; based on said deducing, determining whether said user is (A) an authorized user, or (B) an attacker posing as the authorized user and gaining unauthorized access to the computerized service.

In some embodiments, the method may comprise: monitoring a rate of manual data entry by said user into a form of said computerized service; if said rate of manual data entry is generally constant for all fields in said form, then determining that said user is an attacker posing as the authorized user.

In some embodiments, the method may comprise: calculating a typing speed of data entry by said user, for each field in a form of said computerized service; if the typing speed of data entry by said user, is generally constant for all fields in said form of the computerized service, then determining that said user is an attacker posing as the authorized user.

In some embodiments, the method may comprise: monitoring a rate of manual data entry by said user into a form of said computerized service; if (a) the rate of manual data entry by said user is generally constant for a first group of fields in said form, and (b) the rate of manual data entry by said user is generally varying for a second group of fields in said form, then determining that said user is an authorized user of the computerized service.

In some embodiments, the method may comprise: monitoring a rate of manual data entry by said user into a form of said computerized service; monitoring deletion operations during manual data entry by said user into said form of said computerized service; based on a combination of (a) the rate of manual data entry, and (b) utilization or non-utilization of deletion operations during manual data entry, determining whether said user is (A) an authorized user, or (B) an attacker posing as the authorized user and gaining unauthorized access to the computerized service.

In some embodiments, the method may comprise: (a) monitoring a rate of manual data entry by said user into a form of said computerized service; (b) determining that the rate of manual data entry by said user into said form is generally constant across all fields of said form; (c) monitoring deletion operations during manual data entry by said user into said form of said computerized service; (d) determining that the number of deletion operations during manual data entry by said user into said form is smaller than a threshold value; (e) based on a combination of the determinations of step (b) and step (d), determining that said user is an attacker posing as the authorized user and gaining unauthorized access to the computerized service.

In some embodiments, the method may comprise: defining a first field, in a form of said computerized service, as a field that users are familiar with and type data therein rapidly; defining a second field, in said form of said computerized service, as a field that users are unfamiliar with and type data therein slowly; detecting that a rate of manual data entry by said user into the first field, is generally similar to the rate of manual data entry by said user into the second field; based on said detecting, determining that said user is an attacker posing as the authorized user and gaining unauthorized access to the computerized service.

In some embodiments, the method may comprise: defining a first field, in a form of said computerized service, as a field that users are familiar with and type data therein rapidly; defining a second field, in said form of said computerized service, as a field that users are unfamiliar with and type data therein slowly; detecting that said user enters data slowly into said first field that was defined as a field that users are familiar with and type data therein rapidly; based on said detecting, determining that said user is an attacker posing as the authorized user and gaining unauthorized access to the computerized service.

In some embodiments, the method may comprise: defining a first field, in a form of said computerized service, as a field that users are familiar with and type data therein rapidly; defining a second field, in said form of said computerized service, as a field that users are unfamiliar with and type data therein slowly; detecting that said user enters data rapidly into said second field that was defined as a field that users are unfamiliar with and type data therein slowly; based on said detecting, determining that said user is an attacker posing as the authorized user and gaining unauthorized access to the computerized service.

In some embodiments, the method may comprise: based on tracking of user interactions via the input unit of said computing device, estimating an actual level of familiarity of said user with a data-item that said user enters into a particular field of a form of said computerized service; based on a field-type of said particular field, determining an expected level of familiarity of authorized users with data-items that they enter into said particular field; comparing between (a) the actual level of familiarity of said user with said data-item entered into said particular field, and (b) the expected level of familiarity that characterizes authorized users who enter data into said particular field; if said comparing indicates a mismatch between the actual level of familiarity and the expected level of familiarity, then determining that said user is an attacker posing as the authorized user.

In some embodiments, the method may comprise: monitoring user interactions of said user with the computerized service, and detecting that said user deleted one or more characters when entering a data-item into a particular field in a form of said computerized service; determining that said particular field is a field that most authorized users are highly familiar with, and that said particular field is a field that most authorized users do not make mistakes when entering data therein; based on said, determining that said user is an attacker posing as the authorized user.

In some embodiments, the method may comprise: monitoring user interactions of said user with the computerized service, and detecting that said user exclusively performed copy-and-paste operations to enter data-items into all fields of a form of said computerized service; based on said detecting, determining that said user is an attacker posing as the authorized user.

In some embodiments, the method may comprise: defining a first field, in a form of said computerized service, as a field that authorized users typically enter data therein by manual character-by-character typing; defining a second field, in said form of said computerized service, as a field that authorized users typically enter data therein by performing copy-and-paste operations; detecting that said user enters data into said first field by performing a copy-and-paste operation instead of by manual character-by-character typing; based on said detecting, determining that said user is an attacker posing as the authorized user and gaining unauthorized access to the computerized service.

In some embodiments, the method may comprise: defining a first group of fields, in a form of said computerized service, as a group of fields that authorized users typically enter data therein by manual character-by-character typing; defining a second group of fields, in said form of said computerized service, as a group of fields that authorized users typically enter data therein by performing copy-and-paste operations; monitoring data entry methods that said user utilizes when said user populates data into fields of said form; detecting that said user performed copy-and-paste operations in at least a first particular field of said form; detecting that said user performed manual character-by-character typing of data in at least a second particular field of said form; if said first particular field belongs to said second group of fields, and if said second particular field belongs to said first group of fields, then determining that said user is an attacker.

In some embodiments, the method may comprise: defining a first group of fields, in a form of said computerized service, as a group of fields that authorized users typically enter data therein by manual character-by-character typing; defining a second group of fields, in said form of said computerized service, as a group of fields that authorized users typically enter data therein by performing copy-and-paste operations; monitoring data entry methods that said user utilizes when said user populates data into fields of said form; detecting that said user performed copy-and-paste operations in at least a first particular field of said form; detecting that said user performed manual character-by-character typing of data in at least a second particular field of said form; if said first particular field belongs to said first group of fields, and if said second particular field belongs to said second group of fields, then determining that said user is an authorized user.

In some embodiments, the method may comprise: monitoring user interactions of said user with a date field in a form of said computerized service; detecting that in a current usage session by said user, said user enters a date into said date field by selecting a date from a drop-down mini-calendar matrix; determining that in a set of previous usage sessions of said user, said user entered dates into date fields via manual character-by-character typing; based on said detecting and said determining, determining that said user is an attacker posing as the authorized user.

In some embodiments, the method may comprise: monitoring user interactions of said user with a form having multiple fields of said computerized service, and tracking whether said user moves a cursor among fields of said form by utilizing a keyboard or by utilizing a pointing device; detecting that in a current usage session by said user, said user moves the cursor among fields of said form by utilizing the keyboard and not the pointing device; determining that in a set of previous usage sessions of said user, said user moved the cursor among fields of said form by utilizing the pointing device and not the keyboard; based on said detecting and said determining, determining that said user is an attacker posing as the authorized user.

In some embodiments, the method may comprise: monitoring user interactions of said user with a form having multiple fields of said computerized service, and tracking whether said user moves a cursor among fields of said form by utilizing a keyboard or by utilizing a pointing device; detecting that in a current usage session by said user, said user moves the cursor among fields of said form by utilizing the pointing device and not the keyboard; determining that in a set of previous usage sessions of said user, said user moved the cursor among fields of said form by utilizing the keyboard and not the pointing device; based on said detecting and said determining, determining that said user is an attacker posing as the authorized user.

In some embodiments, the method may comprise: monitoring user interactions of said user with a form having multiple fields of said computerized service, and tracking whether said user submits the form by utilizing a pointing device to click on a Submit button or by pressing Enter on a keyboard; detecting that in a current usage session by said user, said user submits the form by pressing Enter on the keyboard; determining that in a set of previous usage sessions of said user, said user submitted forms by utilizing the pointing device to click on the Submit button; based on said detecting and said determining, determining that said user is an attacker posing as the authorized user.

In some embodiments, the method may comprise: monitoring user interactions of said user with a form having multiple fields of said computerized service, and tracking whether said user submits the form by utilizing a pointing device to click on a Submit button or by pressing Enter on a keyboard; detecting that in a current usage session by said user, said user submits the form by utilizing the pointing device to click on the Submit button; determining that in a set of previous usage sessions of said user, said user submitted forms by pressing Enter on the keyboard; based on said detecting and said determining, determining that said user is an attacker posing as the authorized user.

In some embodiments, the method may comprise: monitoring user interactions of said user with a form having multiple fields of said computerized service; with regard to a particular field in said form, said particular field associated with at least a first engagement manner and a second data-entry manner, tracking whether said user engages with said particular field by utilizing the first or the second data-entry manner; detecting that in a current usage session by said user, said user engaged with said particular field by utilizing said first data-entry manner; determining that in a set of previous usage sessions of said user, said user engaged with said particular field by utilizing said second data-entry manner; based on said detecting and said determining, determining that said user is an attacker posing as the authorized user.

In some embodiments, the method may comprise: (a) defining a multiple-screen account-creation process for creating a new account associated with the computerized service; (b) presenting a first, fixed, screen of said multiple-screen account creation process, and measuring characteristics of user interactions in said first screen; (c) shuffling the order of remaining screens of said multiple-screens account-creation process, by presenting at least one out-of-order screen earlier relative to a pre-defined sequence of said remaining screens; (d) measuring characteristics of user interaction in said at least one out-of-order screen of the account creation process; (e) determining a change between: (A) the characteristics of user interactions measured in step (b) during the first fixed screen, and (B) the characteristics of user interactions measured in step (d) during the at least one out-of-order screen; (f) based on the changed determined in step (e), determining that said user is an attacker.

In some embodiments, the method may comprise: (a) defining a multiple-screen account-creation process for creating a new account associated with the computerized service; (b) presenting a first, fixed, screen of said multiple-screen account creation process, and measuring characteristics of user interactions in said first screen; wherein said first, fixed, screen is presented with identical content to all users creating new accounts; (c) pseudo-randomly changing a content of a second screen of said multiple-screens account-creation process; (d) measuring characteristics of user interaction in said second screen of the account creation process; (e) comparing between: (A) the characteristics of user interactions measured in step (b) during the first fixed screen of the account-creation process, and (B) the characteristics of user interactions measured in step (d) during the second screen of the account-creation process; and determining that the user interactions in the second screen of the account-creation process exhibit user delays; (f) based on the determining of step (e), determining that said user is an attacker.

In some embodiments, the method may comprise: monitoring user interactions of said user with a form having multiple fields of said computerized service; tracking deletion operations performed by said user, in at least one of the following fields: username field, password field, first name field, last name field; detecting that said user performed at least one deletion operation during entry of data into at least one of the following fields: username field, password field, first name field, last name field; based on said detecting, determining that said user is an attacker.

Modules, elements, systems and/or sub-systems described herein may be implemented by using hardware components and/or software modules; for example, utilizing a processor, a controller, an Integrated Circuit (IC), a logic unit, memory unit, storage unit, input unit, output unit, wireless modem or transceiver, wired modem or transceiver, internal or external power source, database or data repository, Operating System (OS), drivers, software applications, or the like. Some embodiments may utilize client/server architecture, distributed architecture, peer-to-peer architecture, and/or other suitable architectures; as well as one or more wired and/or wireless communication protocols, links and/or networks.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method comprising:
determining whether a user, who utilizes a computing device to interact with a computerized service, is (A) an authorized user, or (B) an attacker posing as the authorized user and gaining unauthorized access to the computerized service;
wherein the determining comprises:
tracking user interactions with the computerized service via an input unit of the computing device;
analyzing the user interactions with the computerized service;
based on analysis of the user interactions with the computerized service, deducing at least one of: (i) changes in data-entry rate of said user, and (ii) level of familiarity of said user with said computerized service;
based on said deducing, determining whether said user is (A) an authorized user, or (B) an attacker posing as the authorized user and gaining unauthorized access to the computerized service.

2. The method of claim 1, comprising:
monitoring a rate of manual data entry by said user into a form of said computerized service;
if said rate of manual data entry is generally constant for all fields in said form, then determining that said user is an attacker posing as the authorized user.

3. The method of claim 1, comprising:
calculating a typing speed of data entry by said user, for each field in a form of said computerized service;
if the typing speed of data entry by said user, is generally constant for all fields in said form of the computerized service, then determining that said user is an attacker posing as the authorized user.

4. The method of claim 1, comprising:
monitoring a rate of manual data entry by said user into a form of said computerized service;
if (a) the rate of manual data entry by said user is generally constant for a first group of fields in said form, and (b) the rate of manual data entry by said user is generally varying for a second group of fields in said form, then determining that said user is an authorized user of the computerized service.

5. The method of claim 1, comprising:
monitoring a rate of manual data entry by said user into a form of said computerized service;
monitoring deletion operations during manual data entry by said user into said form of said computerized service;
based on a combination of (a) the rate of manual data entry, and (b) utilization or non-utilization of deletion operations during manual data entry, determining whether said user is (A) an authorized user, or (B) an attacker posing as the authorized user and gaining unauthorized access to the computerized service.

6. The method of claim 1, comprising:
(a) monitoring a rate of manual data entry by said user into a form of said computerized service;
(b) determining that the rate of manual data entry by said user into said form is generally constant across all fields of said form;
(c) monitoring deletion operations during manual data entry by said user into said form of said computerized service;
(d) determining that the number of deletion operations during manual data entry by said user into said form is smaller than a threshold value;
(e) based on a combination of the determinations of step (b) and step (d), determining that said user is an attacker posing as the authorized user and gaining unauthorized access to the computerized service.

7. The method of claim 1, comprising:
defining a first field, in a form of said computerized service, as a field that users are familiar with and type data therein rapidly;
defining a second field, in said form of said computerized service, as a field that users are unfamiliar with and type data therein slowly;
detecting that a rate of manual data entry by said user into the first field, is generally similar to the rate of manual data entry by said user into the second field;
based on said detecting, determining that said user is an attacker posing as the authorized user and gaining unauthorized access to the computerized service.

8. The method of claim 1, comprising:
defining a first field, in a form of said computerized service, as a field that users are familiar with and type data therein rapidly;
defining a second field, in said form of said computerized service, as a field that users are unfamiliar with and type data therein slowly;
detecting that said user enters data slowly into said first field that was defined as a field that users are familiar with and type data therein rapidly;
based on said detecting, determining that said user is an attacker posing as the authorized user and gaining unauthorized access to the computerized service.

9. The method of claim 1, comprising:
defining a first field, in a form of said computerized service, as a field that users are familiar with and type data therein rapidly;
defining a second field, in said form of said computerized service, as a field that users are unfamiliar with and type data therein slowly;
detecting that said user enters data rapidly into said second field that was defined as a field that users are unfamiliar with and type data therein slowly;
based on said detecting, determining that said user is an attacker posing as the authorized user and gaining unauthorized access to the computerized service.

10. The method of claim 1, comprising:
based on tracking of user interactions via the input unit of said computing device, estimating an actual level of familiarity of said user with a data-item that said user enters into a particular field of a form of said computerized service;
based on a field-type of said particular field, determining an expected level of familiarity of authorized users with data-items that they enter into said particular field;
comparing between (a) the actual level of familiarity of said user with said data-item entered into said particular field, and (b) the expected level of familiarity that characterizes authorized users who enter data into said particular field;
if said comparing indicates a mismatch between the actual level of familiarity and the expected level of familiarity, then determining that said user is an attacker posing as the authorized user.

11. The method of claim 1, comprising:
monitoring user interactions of said user with the computerized service, and detecting that said user deleted one or more characters when entering a data-item into a particular field in a form of said computerized service;
determining that said particular field is a field that most authorized users are highly familiar with, and that said particular field is a field that most authorized users do not make mistakes when entering data therein;
based on said, determining that said user is an attacker posing as the authorized user.

12. The method of claim 1, comprising:
monitoring user interactions of said user with the computerized service, and detecting that said user exclusively performed copy-and-paste operations to enter data-items into all fields of a form of said computerized service;
based on said detecting, determining that said user is an attacker posing as the authorized user.

13. The method of claim 1, comprising:
defining a first field, in a form of said computerized service, as a field that authorized users typically enter data therein by manual character-by-character typing;
defining a second field, in said form of said computerized service, as a field that authorized users typically enter data therein by performing copy-and-paste operations;
detecting that said user enters data into said first field by performing a copy-and-paste operation instead of by manual character-by-character typing;
based on said detecting, determining that said user is an attacker posing as the authorized user and gaining unauthorized access to the computerized service.

14. The method of claim 1, comprising:
defining a first group of fields, in a form of said computerized service, as a group of fields that authorized users typically enter data therein by manual character-by-character typing;
defining a second group of fields, in said form of said computerized service, as a group of fields that authorized users typically enter data therein by performing copy-and-paste operations;
monitoring data entry methods that said user utilizes when said user populates data into fields of said form;
detecting that said user performed copy-and-paste operations in at least a first particular field of said form;
detecting that said user performed manual character-by-character typing of data in at least a second particular field of said form;
if said first particular field belongs to said second group of fields, and if said second particular field belongs to said first group of fields, then determining that said user is an attacker.

15. The method of claim 1, comprising:
defining a first group of fields, in a form of said computerized service, as a group of fields that authorized users typically enter data therein by manual character-by-character typing;
defining a second group of fields, in said form of said computerized service, as a group of fields that authorized users typically enter data therein by performing copy-and-paste operations;
monitoring data entry methods that said user utilizes when said user populates data into fields of said form;
detecting that said user performed copy-and-paste operations in at least a first particular field of said form;
detecting that said user performed manual character-by-character typing of data in at least a second particular field of said form;
if said first particular field belongs to said first group of fields, and if said second particular field belongs to said second group of fields, then determining that said user is an authorized user.

16. The method of claim 1, comprising:
monitoring user interactions of said user with a date field in a form of said computerized service;
detecting that in a current usage session by said user, said user enters a date into said date field by selecting a date from a drop-down mini-calendar matrix;
determining that in a set of previous usage sessions of said user, said user entered dates into date fields via manual character-by-character typing;
based on said detecting and said determining, determining that said user is an attacker posing as the authorized user.

17. The method of claim 1, comprising:
monitoring user interactions of said user with a form having multiple fields of said computerized service, and tracking whether said user moves a cursor among fields of said form by utilizing a keyboard or by utilizing a pointing device;
detecting that in a current usage session by said user, said user moves the cursor among fields of said form by utilizing the keyboard and not the pointing device;
determining that in a set of previous usage sessions of said user, said user moved the cursor among fields of said form by utilizing the pointing device and not the keyboard;
based on said detecting and said determining, determining that said user is an attacker posing as the authorized user.

18. The method of claim 1, comprising:
monitoring user interactions of said user with a form having multiple fields of said computerized service, and tracking whether said user moves a cursor among fields of said form by utilizing a keyboard or by utilizing a pointing device;
detecting that in a current usage session by said user, said user moves the cursor among fields of said form by utilizing the pointing device and not the keyboard;
determining that in a set of previous usage sessions of said user, said user moved the cursor among fields of said form by utilizing the keyboard and not the pointing device;
based on said detecting and said determining, determining that said user is an attacker posing as the authorized user.

19. The method of claim 1, comprising:
monitoring user interactions of said user with a form having multiple fields of said computerized service, and tracking whether said user submits the form by utilizing a pointing device to click on a Submit button or by pressing Enter on a keyboard;
detecting that in a current usage session by said user, said user submits the form by pressing Enter on the keyboard;
determining that in a set of previous usage sessions of said user, said user submitted forms by utilizing the pointing device to click on the Submit button;
based on said detecting and said determining, determining that said user is an attacker posing as the authorized user.

20. The method of claim 1, comprising:
monitoring user interactions of said user with a form having multiple fields of said computerized service, and tracking whether said user submits the form by utilizing a pointing device to click on a Submit button or by pressing Enter on a keyboard;
detecting that in a current usage session by said user, said user submits the form by utilizing the pointing device to click on the Submit button;
determining that in a set of previous usage sessions of said user, said user submitted forms by pressing Enter on the keyboard;
based on said detecting and said determining, determining that said user is an attacker posing as the authorized user.

21. The method of claim 1, comprising:
monitoring user interactions of said user with a form having multiple fields of said computerized service;
with regard to a particular field in said form, said particular field associated with at least a first engagement manner and a second data-entry manner, tracking whether said user engages with said particular field by utilizing the first or the second data-entry manner;
detecting that in a current usage session by said user, said user engaged with said particular field by utilizing said first data-entry manner;
determining that in a set of previous usage sessions of said user, said user engaged with said particular field by utilizing said second data-entry manner;
based on said detecting and said determining, determining that said user is an attacker posing as the authorized user.

22. The method of claim 1, comprising:
(a) defining a multiple-screen account-creation process for creating a new account associated with the computerized service;
(b) presenting a first, fixed, screen of said multiple-screen account creation process, and measuring characteristics of user interactions in said first screen;
(c) shuffling the order of remaining screens of said multiple-screens account-creation process, by presenting at least one out-of-order screen earlier relative to a pre-defined sequence of said remaining screens;
(d) measuring characteristics of user interaction in said at least one out-of-order screen of the account creation process;
(e) determining a change between: (A) the characteristics of user interactions measured in step (b) during the first fixed screen, and (B) the characteristics of user interactions measured in step (d) during the at least one out-of-order screen;
(f) based on the changed determined in step (e), determining that said user is an attacker.

23. The method of claim 1, comprising:
(a) defining a multiple-screen account-creation process for creating a new account associated with the computerized service;
(b) presenting a first, fixed, screen of said multiple-screen account creation process, and measuring characteristics of user interactions in said first screen; wherein said first, fixed, screen is presented with identical content to all users creating new accounts;
(c) pseudo-randomly changing a content of a second screen of said multiple-screens account-creation process;
(d) measuring characteristics of user interaction in said second screen of the account creation process;
(e) comparing between: (A) the characteristics of user interactions measured in step (b) during the first fixed screen of the account-creation process, and (B) the characteristics of user interactions measured in step (d) during the second screen of the account-creation process; and determining that the user interactions in the second screen of the account-creation process exhibit user delays;
(f) based on the determining of step (e), determining that said user is an attacker.

24. The method of claim 1, comprising:
monitoring user interactions of said user with a form having multiple fields of said computerized service;
tracking deletion operations performed by said user, in at least one of the following fields: username field, password field, first name field, last name field;
detecting that said user performed at least one deletion operation during entry of data into at least one of the following fields: username field, password field, first name field, last name field;
based on said detecting, determining that said user is an attacker.
